(19) United States
(12) Patent Application Publication
(10) Pub. No.: US 2010/0177057 A1
(43) Pub. Date: Jul. 15, 2010

(54) SYSTEM AND METHOD FOR DETECTING SHOCKS TO A FORCE-BASED TOUCH PANEL

(75) Inventors: Randy Flint, Kaysville, UT (US); David A. Soss, Salt Lake City, UT (US); Catherine B. Miller, Salt Lake City, UT (US)

Correspondence Address: THORPE NORTH & WESTERN, LLP., P.O. Box 1219, SANDY, UT, 84091-1219, US

(73) Assignee: QSI CORPORATION, Salt Lake City, UT (US)

(21) Appl. No.: 12/353,178

(22) Filed: Jan. 13, 2009

(51) Int. Cl. G06F 3/045

(52) U.S. Cl. 345/174

(57) ABSTRACT

A system and method for detecting a shock to a force-based touch panel is disclosed. The system comprises at least one force sensor operable with the force-based touch panel to measure a force applied to the touch panel to provide at least one force sensor signal. An accelerometer is used to sense vibrational acceleration of the force-based touch panel to form an acceleration signal. A shock detector is used to inhibit detection of a touch event on the touch panel for a predetermined period when an amplitude of the correlated shock signal is greater than a selected threshold.

### BACKGROUND

Input devices (e.g., a touch panel or touch pad) are designed to detect the application of an object and to determine one or more specific characteristics of or relating to the object as relating to the input device, such as the location of the object as it is acting on the input device, the magnitude of force applied by the object to the input device, etc. Examples of some of the different applications in which input devices may be found include computer display devices, kiosks, games, point of sale terminals, vending machines, medical devices, keypads, keyboards, and others.

In a force-based touch panel device, the characteristics used to detect an application of an object to the device are measured by determining the force that is applied to the device. Shaking and vibration caused by external sources other than the intended object acting on the input device can also be detected as a force or acceleration that occurs at the device. Thus, when a force-based touch panel device is used in an environment that is subject to such external vibrations, the effect of the vibrations is to reduce the accuracy of an intended reported touch location on the input device, or to cause the device to report touches when none actually exist.

Relatively large levels of vibration or shaking of short durations are referred to as shocks. As with vibrations, shocks to the touch panel can be registered as a touch. Previous attempts to reduce the affect of shocks to a touch panel have been to ignore a touch event if the measured acceleration exceeds a set threshold. This has the disadvantage of causing touch events to be incorrectly ignored if there is a shock that has a minimal affect to the touch panel. Another approach has been to ignore a touch event if there is a rapid change in the measured force signal associated with the touch panel. However, this has the disadvantage of ignoring rapid touches applied to the touch panel.

### SUMMARY

A system and method for detecting a shock to a force-based touch panel is disclosed. The method includes sensing a force applied to the touch panel using at least one force-sensor to obtain at least one force-sensor signal. An acceleration of the force-based touch panel is measured to form an acceleration signal. The force-sensor signal is multiplied with the acceleration signal to form a correlated shock signal. Detection of a touch on the touch panel is inhibited for a predetermined period when the amplitude of the correlated shock signal is greater than a selected threshold.

The system comprises at least one force sensor operable with the force-based touch panel to measure a force applied to the touch panel to provide at least one force sensor signal. An accelerometer is used to sense vibrational acceleration of the force-based touch panel to form an acceleration signal. A shock detector is used to inhibit detection of a touch event on the touch panel for a predetermined period when the amplitude of the correlated shock signal is greater than a selected threshold.

### BRIEF DESCRIPTION OF THE DRAWINGS

Features and advantages of the invention will be apparent from the detailed description which follows, taken in conjunction with the accompanying drawings, which together illustrate, by way of example, features of the invention; and, wherein:

FIG. 1a is an illustration of an exemplary output amplitude of an accelerometer over a time period;

FIG. 1b is an illustration of an exemplary output of force sensors in response to the acceleration of FIG. 1a over the time period;

FIG. 1c is an illustration of the product of the accelerometer amplitude of FIG. 1a and the force sensor output of FIG. 1b to form a correlated shock signal in accordance with an embodiment of the present invention;

FIG. 1d is an illustration of an output of a shock detector having a predetermined threshold to the correlated shock signal in accordance with an embodiment of the present invention;

FIG. 2 is a diagram showing an exemplary embodiment of a shock detector used to keep a force-based touch panel from responding to external transient shocks in accordance with an embodiment of the present invention;

FIG. 3 illustrates a shock detector using comparators in accordance with an embodiment of the present invention;

FIG. 4 illustrates a shock detector using an absolute value of a multiplier output in accordance with an embodiment of the present invention;

FIG. 5 illustrates a shock detector using a multiplier and comparators in accordance with an embodiment of the present invention;

FIG. 6 illustrates a shock detector using a multiplier and a single comparator in accordance with an embodiment of the present invention;

FIG. 7 illustrates a shock detector using an absolute value of a multiplier output with a first and second threshold in accordance with an embodiment of the present invention; and

FIG. 8 is a flow chart depicting a method for detecting a shock to a force-based touch panel.

Reference will now be made to the exemplary embodiments illustrated, and specific language will be used herein to describe the same. It will nevertheless be understood that no limitation of the scope of the invention is thereby intended.

### DETAILED DESCRIPTION OF EXAMPLE EMBODIMENTS

A location of a user's touch on a force-based touch panel may be calculated using a plurality of force sensors. For example, a force sensor may be positioned at each of the four corners of the touch panel. The force sensors can be configured to measure a force and output a force-sensor signal that corresponds with the level of force detected at each force sensor. The touch location can be determined based on the amount of force sensed by the sensors in each corner. However, external vibrations and shocks are also detected by the force-based touch panel force sensors, with the detected force being proportional to the mass of the touch panel times the acceleration caused by the vibration or shock. The external vibration and shocks can cause noise and inaccuracies in the force sensor signals, thereby leading to an inaccurate determination of a user's touch location on the panel, or even an unintended touch event. The random and changing nature of external vibrations and shocks on a force-based touch panel make it difficult to accurately detect and cancel the vibrational and shock effects on the touch panel.

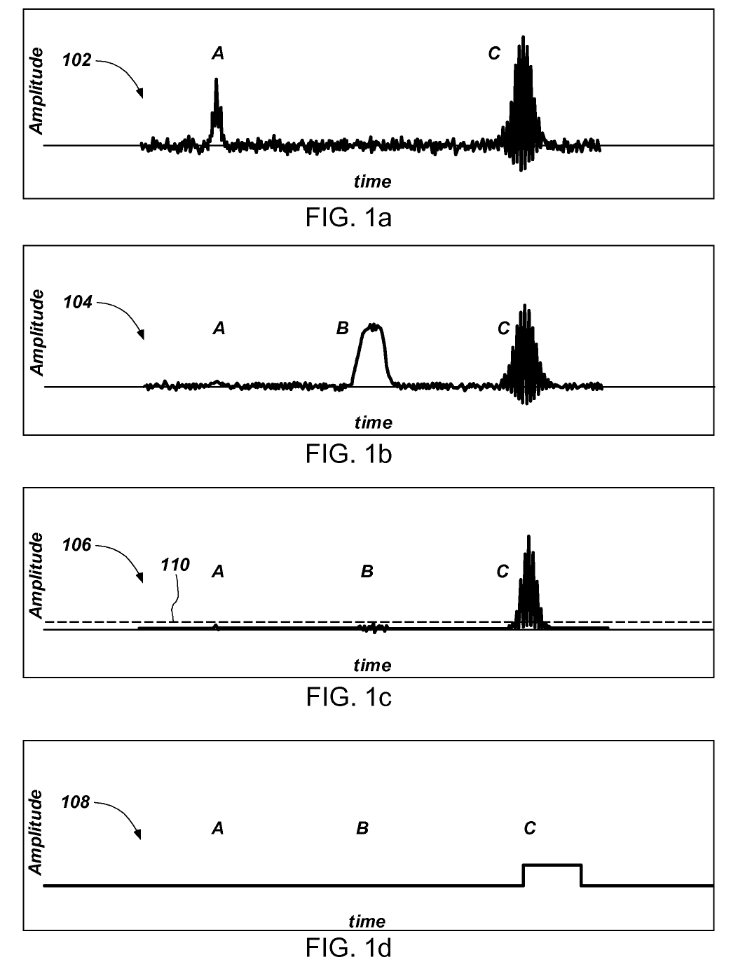

External vibrations and shocks can be measured independently of the force sensors using an accelerometer configured to output an acceleration signal. In accordance with one embodiment of the present invention, it has been discovered that a shock to a force-based touch panel can be accurately detected by multiplying the acceleration signal and the force-sensor signal from at least one force sensor. For example, FIG. 1a shows an exemplary illustration of an accelerometer output (amplitude) versus time signal 102 for three different events: A, B and C. FIG. 1b represents the corresponding total force-sensor signal 104 (the sum of all of the force-sensor outputs) for the three events. FIG. 1c shows the product of the acceleration signal and the force-sensor signal to form a correlated shock signal 106. FIG. 1d shows an output signal set to change at a selected threshold output level of the correlated shock signal 106.

Event A, as shown in FIGS. 1a-1d, represents a short duration shock to the structure that supports the touch panel. The short duration shock is detected by the accelerometer, as shown in the accelerometer signal 102. However, the force-sensor signal 104 summed from the force sensors barely registers the short duration shock of event A, as shown in FIG. 1b. If the accelerometer alone was used to detect a shock, then the touch panel may be turned off for a period, even though the shock event did not substantially affect the force sensors. Thus, the use of only an accelerometer or other type of acceleration sensor to detect a relatively short duration shock may cause the touch panel to be deactivated more often than necessary, thereby increasing the chances of missing an actual touch event when the touch panel is turned off.

However, when the accelerometer signal 102, as shown in FIG. 1a, is multiplied by the total force-sensor signal 104, as shown in FIG. 1b, the result is a substantially minimal signal at event A, as shown in the correlated shock signal 106 of FIG. 1c. A relatively low threshold level 110 can be selected relative to the correlated shock signal 106. The product of the accelerometer signal and the total force-sensor signal for event A is below the selected threshold, so there is no output shown in the shock detector output signal 108, as shown in FIG. 1d.

Event B represents a user touching the panel, as shown by the total force-sensor signal in FIG. 1b. Since the accelerometer is attached to the support frame, and not the touch panel itself, little to no acceleration is detected by the accelerometer when a touch event occurs, as shown in acceleration signal 102 of FIG. 1a. Thus, the correlated shock signal 106 shows a minimal signal at event B that is below the threshold level 110, so there is no output shown in the shock detector output signal 108.

Event C represents a shock to the structure that causes an output from force-sensors coupled to the touch panel. A response is shown in both the acceleration signal 102 and the total force-sensor output signal 104 at event C. The multiplication of these two signals results in a relatively large signal in the correlated shock signal 106. The signal at event C is substantially greater than the threshold level 110, thereby resulting in a change in output at even C shown in the shock detector output signal 108. The shock detector output signal can be used to deactivate the touch panel for a predetermined period to allow the shock detected by the force-sensors to be ignored. The duration of the change in output from the shock detector may last only as long as the correlated shock signal is greater than the threshold level. Alternatively, the change in output from the shock detector may last for a predetermined amount of time after the shock has ceased. This will be discussed more fully below.

In addition to using the correlated shock signal 106 to distinguish a shock event (A,C) from a touch event (B) on the touch panel, additional information can be used to increase the ability to differentiate between the events with a high probability. For example, the frequency content of a mechanical shock is often higher than that of a user's press on the touch panel. This fact can be used to distinguish a mechanical shock from a user's press or touch. In one embodiment, a measure of the magnitude of the shock can be obtained by passing the force sensor data, and/or the accelerometer sensor data through a high-pass filter that has a cutoff frequency above the typical frequency content of a user's touch. Once the magnitude of the shock is known, it can be compared against a predetermined threshold, as previously discussed.

In one embodiment, the accelerometer can be mounted to the same structure as the touch panel, thereby enabling the accelerometer to detect substantially similar vibrations that affect the touch panel. The accelerometer is typically mounted to the support structure of the touch panel, and not to the touch panel itself. This minimizes the affect of a user's touch being detected by the accelerometer. The accelerometer can be mounted rigidly to the touch panel support structure to allow the accelerometer to accurately measure vibrations that affect the touch panel. For example, it can be mounted on a printed circuit board (PCB) that is attached to the support structure.

The accelerometer may be a micro-electro-mechanical system (MEMS) type accelerometer. Alternatively, the accelerometer may be a mass that is attached to a force sensor, such as a beam having strain sensors located on the beam to measure the force caused by the acceleration of the beam's mass.

It should be noted that the accelerometer may have a DC component, or may be configured such that there is no DC component. Examples of accelerometers that inherently have no DC response are piezoelectric accelerometers and dynamic accelerometers. Dynamic accelerometers have a coil that moves in a magnetic field. Accelerometers that have a DC component include piezoresistive accelerometers and some types of MEMS accelerometers that include integrated signal conditioning. The use of any of these types of accelerometers is considered to be within the scope of the present invention.

In one embodiment, a high-pass filtering operation can be implemented as either a finite impulse response (FIR) or infinite impulse response filter with the cutoff frequency set above the frequency content of the user's touch. A typical cutoff frequency can be around 12 Hz. One embodiment for applying the high-pass filters to the sensor data is to apply the filter to a linear combination of the force sensor signals. A second embodiment applies the high-pass filter to each of the force sensor signals before taking a linear combination of the results.

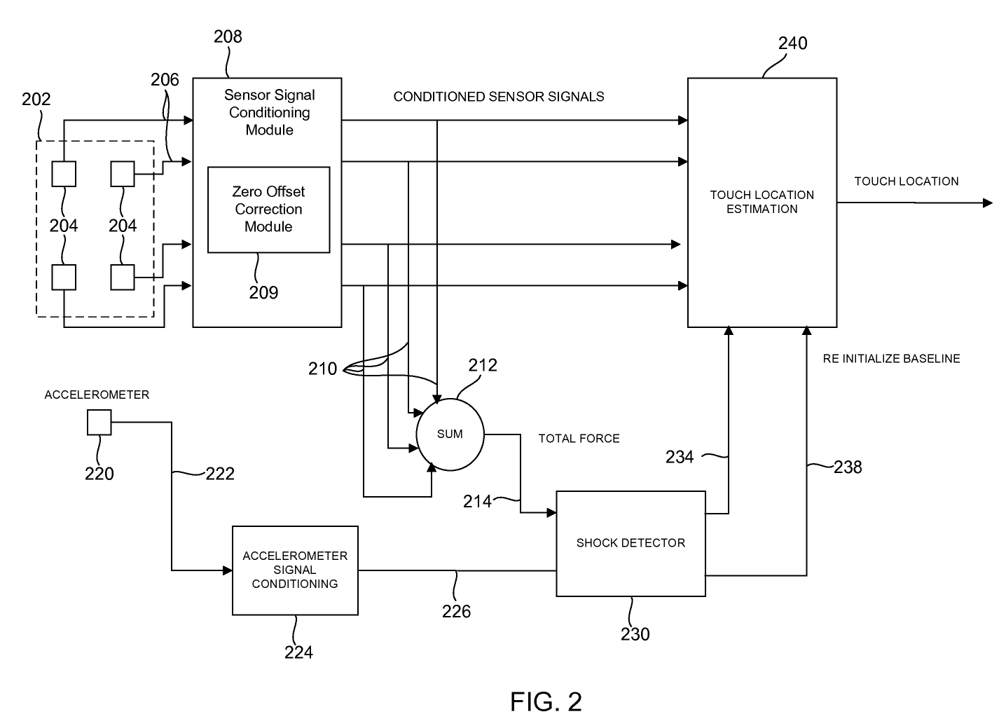

One exemplary embodiment of a shock detector used to keep a force-based touch panel from responding to external transient shocks is illustrated in FIG. 2. A touch panel 202 is shown coupled to a plurality of force sensors 204. In one embodiment, a separate force sensor may be located near each corner of the touch panel. Alternatively, a single force sensor can be used. The force sensors provide an output in response to pressure that is applied to the touch panel. The output of the sensors can be amplified, filtered, and have other signal conditioning 208 performed. The signal conditioning may be done using discrete components or an integrated circuit. The signal conditioning can be accomplished using a processor such as an application specific integrated circuit (ASIC) or field programmable gate array (FPGA). The conditioned force sensor outputs 210 can be summed 212 to produce a total force sensor signal 214.

An accelerometer 220 or other type of device configured to measure acceleration can be mounted on the touch panel support structure and not to the touch panel itself. This minimizes the affect of a user's touch being detected by the accelerometer. The accelerometer can be oriented to respond to transient shocks that may affect the force sensors 204. The accelerometer can be mounted rigidly to the touch panel support structure to allow the accelerometer to accurately measure vibrations and/or shocks that affect the touch panel. For example, it can be mounted on a printed circuit board (PCB) that is attached to the support structure. The accelerometer may be a micro-electro-mechanical system (MEMS) type accelerometer. Alternatively, the accelerometer may be a mass that is attached to a force sensor, such as a beam having strain sensors located on the beam to measure the force caused by the acceleration of the beam's mass. A gyroscope type device can also be used to determine acceleration based on a change in angular velocity.

The accelerometer 220 can output a signal 222 that is correlated with a change in velocity of the touch panel support structure. The acceleration signal can undergo conditioning 224 such as amplification, filtering, and so forth to provide a conditioned acceleration signal 226 that is input to a shock detector 230 along with the total force sensor signal 214. The shock detector is operable to use both the conditioned acceleration signal and the total force sensor signal to determine if there is a transient shock sufficiently large for the force sensors to output a signal that can register as a touch, thereby creating a false touch. The shock detector is configured to output a shock detector signal 234 to a touch location estimator 240. When the shock detector registers that a shock has occurred, the shock detector signal is used to inhibit detection of a touch on the touch panel for a predetermined period of time to reduce and/or significantly eliminate incorrect sensing of false touches that are actually caused by shocks to the touch panel.

In another embodiment, a shock detection system can also be used to determine whether a baseline output value of the force sensors 204 should be recalculated. The baseline output value is the output of the force sensors when no external weight or force is applied to the touch panel 202. The value is substantially dependent on variables such as the weight of the panel, the sensitivity of the force sensors, the angle of the panel with respect to the gravitational force, and so forth. The baseline output value is typically determined during manufacture and subtracted electronically to provide a baseline for determining when a touch event has occurred. The baseline output value typically remains fairly constant as long as significant changes are not made to characteristics and position of the touch panel device. Alternatively, in some shock detector systems the baseline output value is updated periodically.

However, in certain embodiments of the touch panel 202, if a sufficiently large shock is received at the touch panel, the shock may actually permanently alter the physical characteristics of the panel and/or force sensors 204, thereby potentially changing the baseline output of the force sensors. This change in baseline output may affect the overall functioning of the touch panel. Until the baseline output value is updated, the touch panel may not function correctly. In order to compensate for physical changes caused by a large shock, the shock detector can be used to output a re-initialize signal 238 that can be used to measure the new baseline values of the touch panel and to re-initialize an updated baseline measurement value.

The signal conditioning module 208 can include amplifiers and analog to digital converters that have a limited dynamic range of signal amplitude that they are designed to accommodate. In the event of a relatively large shock that causes an output of a force sensor 204 to change, the altered output may be outside the range dynamic range of one or more components (or integrated components) in the signal conditioning module. This can cause the one or more components to become overloaded, thereby limiting the ability of the signal conditioning module to provide a desired output.

To overcome this limitation, a zero offset correction module 209 can be used. The zero offset correction module can be separate from, but in electrical communication with the signal conditioning module. Alternatively, the zero offset correction module and signal conditioning module may be included in the same discrete circuit or integrated circuit such as an ASIC or FPGA. The zero offset correction module can provide a coarser zero offset that is applied prior to the limiting circuits described above. When a shock is detected the zero offset correction module can be used to adjust the output of one or more force sensors 204 until the force sensor output value is within the limited dynamic range of the signal conditioning module. The signal conditioning module can then be used to provide a fine adjustment that can be used to provide an updated baseline output value.

The ability to update the baseline output value of the force sensors when a shock occurs can enable the force sensor system to continue to operate in a desired fashion after the shock. When a shock is detected that significantly alters the baseline output value of the force sensors, the baseline output value can be updated in a relatively short time period, such as within a few hundred milliseconds. This relatively short period can enable the baseline output value to be updated with sufficient speed that a user may not notice any change in the operation of the force-based touch panel system, even after it receives a fairly severe blow.

In one embodiment, the shock detector 230 can output a baseline re-initialization signal 238, such as a digital high or a digital low, from the shock detector when the correlated shock signal 106 (FIG. 1c) is greater than a predetermined amount. The actual value at which a new baseline is calculated is dependent on the construction of the touch panel device, such as the size of the touch panel, the materials used, the type of force sensors used, and so forth. A baseline re-initialization level may be set at a level that is typically several times greater than the shock threshold level 110 used to detect a shock. The baseline signal can be sent to the touch location estimator 240, which can be used to re-initialize the baseline measurement. In one embodiment, the baseline measurement may be adjusted to compensate for a change caused by a shock by adjusting an offset value of one or more of the force sensors.

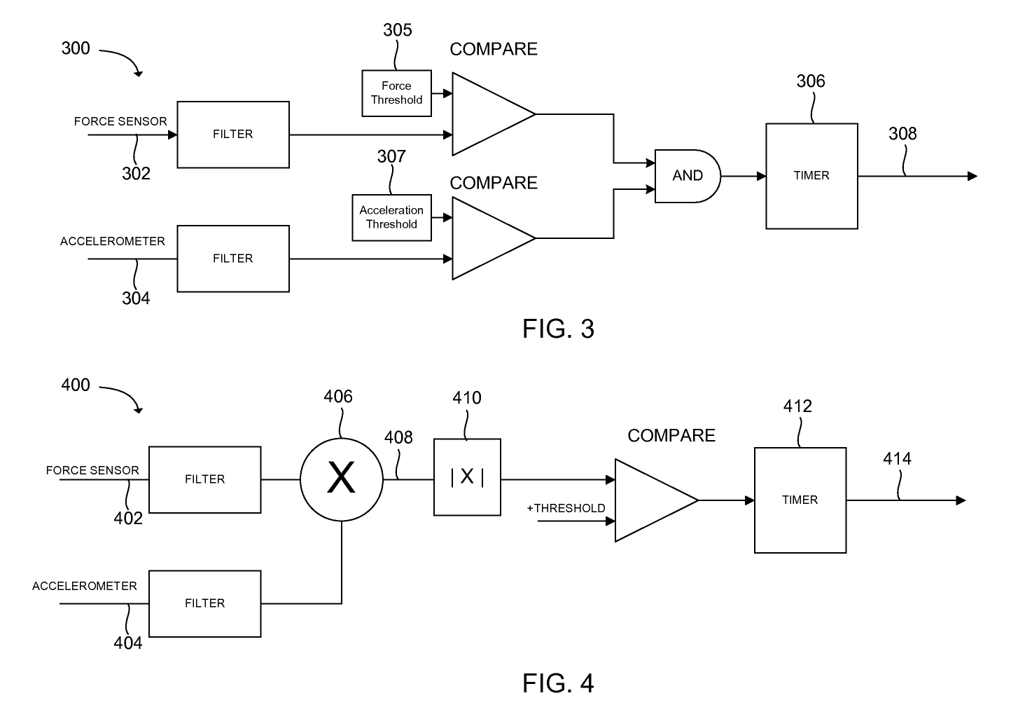

One exemplary embodiment of a shock detector 300 is illustrated in FIG. 3. A total force sensor signal 302 and an acceleration signal 304 can be filtered and compared to threshold levels using standard logic. If both the total force sensor signal and the accelerometer signal are greater than the threshold force threshold level 305 and the acceleration threshold level 307, respectively, then a timer 306 can be activated that is operable to output a signal 308 to inhibit detection of pressure on the touch panel for a predetermined period. However, this embodiment may be overly susceptible to noise in the input signals. If the threshold levels are set above the noise level, the detector may not respond to lower amplitude shocks. Additionally, this method only detects temporal correlation of the signals without accounting for their amplitudes.

Another exemplary embodiment of a shock detector 400 is illustrated in FIG. 4. In this embodiment, a total force sensor signal 402 and an acceleration signal 404 can be filtered and multiplied 406 to form a correlated shock signal 408. The absolute value 410 of the correlated shock signal can be compared to a positive threshold value. If the absolute value of the correlated shock signal is greater than the threshold, a signal can be sent to activate a timer 412 that is operable to output a signal 414 to inhibit detection of pressure on the touch panel for a predetermined period.

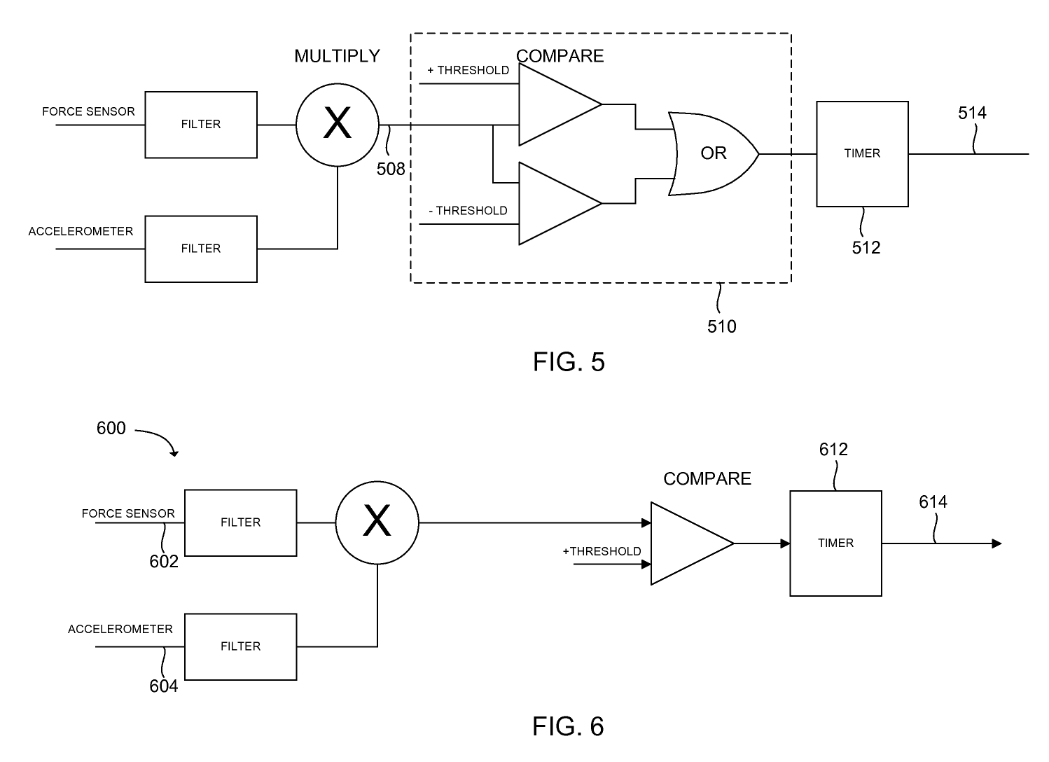

Instead of using the absolute value 410, the same function can be accomplished with two comparators and an OR function 510, as illustrated in FIG. 5. The correlated shock signal 508 can be compared with a positive and a negative threshold, as can be appreciated. A shock event is declared and a signal can be sent to activate a timer 512 that is operable to output a signal 514 if the product is outside of the range bounded by the two thresholds. In this case, the two thresholds may have different values.

Omitting the absolute value function, as illustrated in FIG. 6, results in a shock event being declared and the timer 612 outputting a signal 614 only if the total force sensor signal 602 and an acceleration signal 604 are in phase. This provides a simple implementation which may be suitable for some applications.

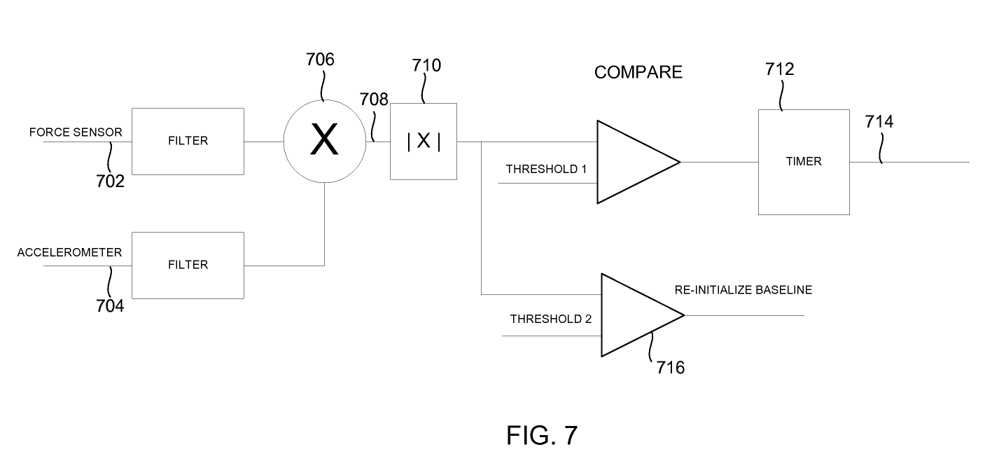

Another embodiment is illustrated in FIG. 7. The embodiment of FIG. 7 is similar to that of FIG. 4 with a second comparator 716 added. The threshold on the second comparator can be set at a higher threshold level than the first comparator. The second comparator's output can be used to output a signal 238 to the touch location estimator 240 (FIG. 4) to enable a baseline estimate to be re-initialized or updated in order to compensate for a possible permanent or semi-permanent alteration of the baseline level, as previously discussed.

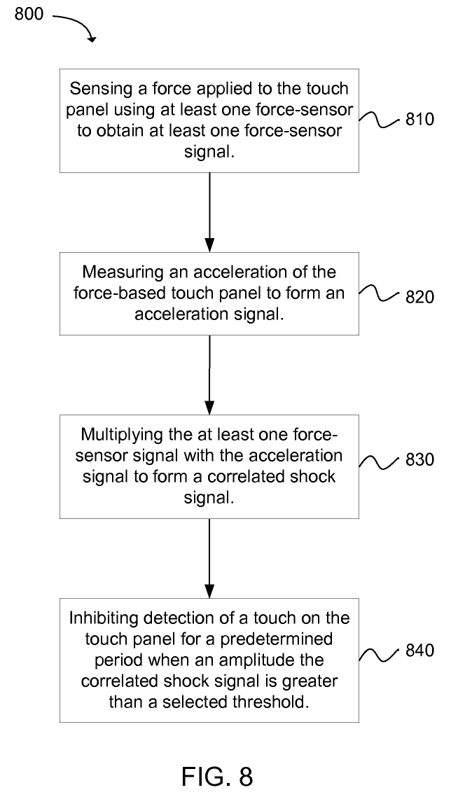

Another embodiment provides a method 800 for detecting a shock to a force-based touch panel, as illustrated in the flow chart depicted in FIG. 8. The method includes the operation of sensing 810 a force applied to the touch panel using at least one force-sensor to obtain at least one force-sensor signal. A plurality of force sensors may be used to determine a location of a touch on the touch panel. The touch sensors may be located at a perimeter of the touch panel.

The method 800 includes the additional operation of measuring 820 an acceleration of the force-based touch panel to form an acceleration signal. An accelerometer may be coupled to a support structure of the touch panel to minimize the output of the accelerometer during an actual touch event on the touch panel.

A further operation of the method 800 provides for multiplying 830 the at least one force-sensor signal with the acceleration signal to form a correlated shock signal. As previously discussed, the correlated shock signal can minimize incorrect shock detection with the accelerometer while maximizing the amplitude of the correlated shock signal during a shock event that is detected by the force sensor signal(s).

An additional operation includes inhibiting detection of a touch on the touch panel for a predetermined period when an amplitude of the correlated shock signal is greater than a selected threshold. By inhibiting detection of a touch on the touch panel for a predetermined period during a shock event, the detection of a false touch event that is actually a shock event can be minimized, thereby increasing the accuracy of touch detection at the touch panel.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A method for detecting a shock to a force-based touch panel, comprising:
sensing a force applied to the touch panel using at least one force-sensor to obtain at least one force-sensor signal;
measuring an acceleration of the force-based touch panel to form an acceleration signal;
multiplying the at least one force-sensor signal with the acceleration signal to form a correlated shock signal;
inhibiting detection of a touch on the touch panel for a predetermined period when an amplitude of the correlated shock signal is greater than a selected threshold.

2. A method as in claim 1, wherein inhibiting detection of a touch on the touch panel for a predetermined period further comprises inhibiting detection of a touch for a selected period of time after the correlated shock signal is below the selected threshold.

3. A method as in claim 1, further comprising filtering at least one of the force-sensor signal and the acceleration signal using a high-pass filter having a cutoff frequency greater than a typical frequency content of a user's touch.

4. A method as in claim 3, further comprising filtering at least one of the force-sensor signal and the acceleration signal with one of a finite impulse response and an infinite impulse response filter, wherein the cutoff frequency is greater than the typical frequency content of the user's touch.

5. A method as in claim 4, further comprising filtering at least one of the force-sensor signal and the acceleration signal with a selected high-pass filter having a cutoff frequency that is about 12 Hz.

6. A method as in claim 3, further comprising filtering a linear combination of a plurality of force-sensor signals to obtain the at least one force-sensor signal.

7. A method as in claim 3, further comprising filtering each of a plurality of force-sensor signals individually prior to adding individual signals of each force-sensor signal.

8. A method as in claim 1, further comprising comparing an amplitude of the correlated shock signal with a baseline re-initialization threshold and performing a baseline re-initialization when the correlated shock signal is greater than the baseline re-initialization threshold.

9. A method as in claim 1, further comprising comparing an absolute value of the correlated shock signal to a shock signal threshold and a baseline re-initialization threshold to provide a phase-independent comparison of the correlated shock signal with the shock signal threshold and a baseline re-initialization threshold.

10. A system for detecting a shock in a force-based touch panel, comprising:
at least one force sensor operable with the force-based touch panel to measure a force applied to the touch panel to provide at least one force sensor signal;
an accelerometer operable with the force-based touch panel to sense a vibrational acceleration of the force-based touch panel to form an acceleration signal; and
a shock detector operable to inhibit detection of a touch event on the touch panel for a predetermined period when an amplitude of the correlated shock signal is greater than a selected threshold.

11. A system as in claim 10, wherein the shock detector comprises:
a multiplier configured to multiply the at least one force sensor signal with the acceleration signal to form the correlated shock signal; and
a comparator having an output used to inhibit detection of the touch event on the touch panel for a predetermined period when an amplitude of the correlated shock signal is greater than a selected threshold.

12. A system as in claim 11, wherein the shock detector further comprises a means for determining an absolute value of the correlated shock signal to provide a phase independent comparison of the correlated shock signal with the shock signal threshold and a baseline re-initialization threshold.

13. A system as in claim 10, wherein the accelerometer has no direct current response and is selected from the group consisting of a piezoelectric accelerometer and a dynamic accelerometer.

14. The system of claim 10, wherein the accelerometer has a direct current response and is selected from the group consisting of a piezoresistive accelerometer, a micro-electro-mechanical system (MEMS) accelerometer based on capacitive sensing, and a MEMS sensor based on piezoelectric sensing.

15. The system of claim 10, wherein the accelerometer is attached to a structure to which the force-based touch panel is mounted to enable the accelerometer to accurately sense the acceleration of the force-based touch panel while minimizing detection of movement caused by the force applied to the touch panel.

16. The system of claim 10, further comprising a high pass filter comprising at least one of a finite impulse response filter and an infinite impulse response filter, the high pass filter operable to filter at least one of the acceleration signal and the at least one force sensor signal with a cutoff frequency greater than a typical frequency content of the touch event.

17. The system of claim 10, further comprising a zero offset correction module configured to provide a coarse adjustment to an output of the at least one force sensor to enable a baseline value to be adjusted when a shock to the force-based touch panel causes a substantially permanent change in a baseline output of the at least one force sensor.

18. A system for inhibiting detection of a touch event during a shock event on a force-based touch panel, comprising:
at least one force sensor operable with the force-based touch panel to measure a force applied to the touch panel to provide at least one force sensor signal;
means for measuring an acceleration of the force-based touch panel to form an acceleration signal;
means for multiplying the at least one force sensor signal with the acceleration signal to form a correlated shock signal; and
means for inhibiting detection of a touch on the touch panel for a predetermined period when an amplitude of the correlated shock signal is greater than a selected threshold

19. A system as in claim 18, further comprising a means for re-initializing a baseline measurement when the correlated shock signal is greater than a baseline re-initialization threshold.
